(19) United States
(12) Patent Application Publication
(10) Pub. No.: US 2012/0137985 A1
(43) Pub. Date: Jun. 7, 2012

(54) Pet toy with motion reactive bellows noisemaker

(75) Inventor: Kyle Hansen, Castle Rock, CO (US)

(73) Assignee: The Kyjen Company, Inc.

(21) Appl. No.: 12/928,012

(22) Filed: Dec. 1, 2010

(51) Int. Cl. A01K 29/00

(52) U.S. Cl. 119/707

(57) ABSTRACT

The invention relates to a novel pet toy that is reactive to a shaking motion produced by an animal playing with the toy as opposed to the animal having to bite or compress the toy. An accordion bellows and reed mechanism located inside the toy's casing compresses in response to the shaking motion and intakes air which flows through the reed and produces sound. The bellows then returns to a resting state when not activated by motion.

No multiple parts, and no complicated mechanics or human interaction is required. Nor does the inventive noisemaker appear or function in any fashion similar to Thornell.

Regarding Claim 3, Thornell does not depict shaking as a cause for the noisemaking effect of the inventive bellows. In the specification and figures, Thornell discloses that a separate “head piece” is pressed upon by a human, not a pet, and complicated mechanics then engage to produce some reaction. Thornell (col. 2, lines 15-1) “In operation, downward movement of the operating handle or rod effects downward movement of the second cylinder, and by means of the latch spring, corresponding to downward movement of the actuations member”. Not only is this so far beyond the scope of the inventive toy and its function, there is no citing of an “accordion bellows” in Thornell at all. This is false.

Regarding Claims 4 and 5, again, Thornell discloses a complicated litany of processes and mechanics, occurring within a two-piece mechanically operated housing, which bears no resemblance in form or function to the inventive bellows noisemaking toy. There is no “reed” cited in Thornell. Again, this is false. There is no “accordion bellows” cited in Thornell. The return to resting state cited in Thornell is a mechanical function requiring certain intervention. It is not a natural reaction of decompression of a plastic accordion bellows noisemaker as in the inventive toy.

The application respectfully states that this prior art used is so beyond the scope, appearance, and function of its inventive toy that the rejection borders on the punitive. Applicant respectfully requests that the amended application be processed and that a patent should be fairly allowed.

### FIELD

The invention relates to a novel pet toy wherein the toy comprises a motion reactive bellows noisemaker housed inside of an encasement. The noisemaker is novel in that it produces sound in response to an animal shaking the toy. The toy in this embodiment is encased in a ball shape, but may be shaped in any encasement form to aid in enticement of the animal.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel method of utilizing an accordion bellows which reacts to the toy being shaken, and produces sound to entice the animal shaking the toy.

Current pet toys contain various noise producing mechanisms. Most prior art pet toys rely on an animal compressing (or biting) on the toy to produce sound. The inventive toy is novel in that it requires the animal to shake the toy to produce sound as emitted from an accordion bellows type noisemaker which fills with air when shaken, causing the bellows to compress lengthwise per the accordion ribs allowing such compression, and returns to resting shape as it straightens.

### THE INVENTION

### Summary, Objects and Advantages

Pet toys are obviously created to entertain and teach pets, and their functionality is key in making the toys viable purchases for pet owners. The inventive toy utilizes an accordion bellows noisemaker with a reed to produce sound. When shaken by an animal, the accordion bellows compresses and air is emitted through the reed producing sound. The bellows will then naturally decompress and return to its resting shape ready for subsequent motion.

Most squeaking pet toys are activated when a pet chews or presses on the toy. Upon some form of external pressure, the toy will emit a squeaking sound as air is forced into an internal squeaking device. The inventive toy employs the accordion bellows and reed mechanism to produce sound when the animal shakes the toy. Thus, no biting or compression is required.

Since the sound is produced as a result of an animal shaking the inventive toy, it is likely the toy will last longer than one which requires some compression to activate the noisemaker. An animal will learn that the sound is emitted upon shaking of the toy and will be stimulated in a novel way in contrast to simply biting the toy.

For purposes of clear description, the inventive toy is described herein as being encased in a ball shaped enclosure. However, the inventive toy is not limited by the shape of the disclosed enclosure, and may be utilized in a variety of housings.

In summary, the inventive pet toy exhibits advantages and novelty over the art in that the design and functionality make this pet toy more stimulating for the pet, and a superior value for the purchase price by the pet owner.

### BRIEF DESCRIPTION OF THE DRAWINGS

The invention is described in further detail by reference to the drawings in which:

FIG. 1; depicts a view of the end-cap of the bellows which houses the noisemaking reed;

FIG. 2; shows the linear view of the end-cap and reed; and

FIG. 3; illustrates the accordion bellows.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in three relatively simple figures; although sufficiently complex as to illuminate to one skilled in the art of such software architecture, programming, and computer operations a viable method for making or using said invention.

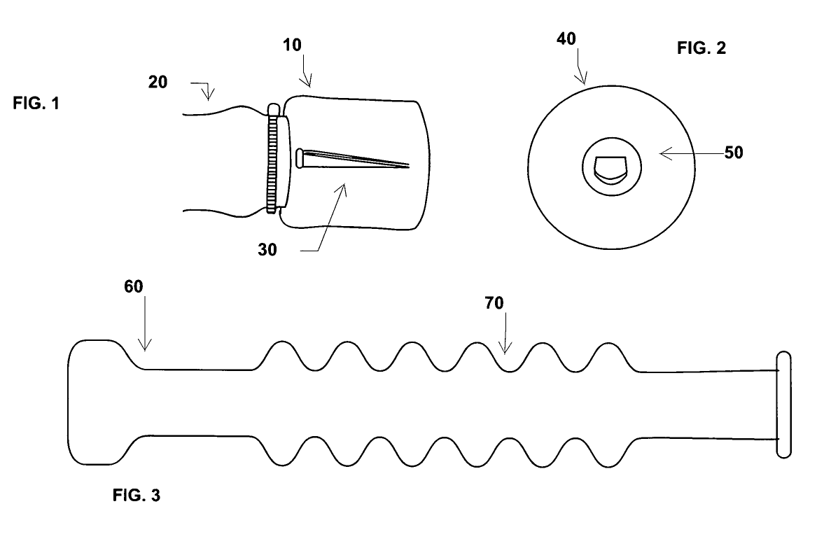

FIG. 1 depicts a simple illustration of the end-cap 10 which attaches to the bellows 20. The reed 30 is shown as being inside the end-cap and the air flow causes the reed to vibrate and produce sound.

FIG. 2 is a linear view as looking inside the end-cap 40 at the reed mechanism The reed 50 is shown as being centered inside the end-cap. After the bellows has been activated by a shaking motion, the bellows will compress and force air through the reed 50, causing sound to be emitted.

FIG. 3 is a side view of the accordion bellows 60. The shape 70 allows the bellows to compress lengthwise being set in motion by an animal shaking the toy, in this case, being described as housing the bellows and reed mechanism inside of a ball-shaped enclosure. The ball is not illustrated herein as the shape is obvious to one in light of the specification.

1) A pet toy with motion reactive bellows noisemaker comprising:
a) an encasement
b) an accordion bellows
c) a vibrating reed located within the bellows.

2) The pet toy of claim 1 wherein the encasement may be a ball or a shaped housing depicting an animal figure.

3) The pet toy of claim 1 wherein the accordion bellows is caused to compress and intake air in reaction to a shaking motion of the toy.

4) The squeaking pet toy of claim 1 wherein the vibrating reed will cause sound to emit upon the intake of air into the accordion bellows.

5) The squeaking pet toy of claim 1 wherein the accordion bellows will return to a resting state when not activated by motion.
